(19) United States
(12) Patent Application Publication
(10) Pub. No.: US 2017/0307787 A1
(43) Pub. Date: Oct. 26, 2017

(54) HEAD MOUNTED APPARATUS AND GRIPPING APPARATUS

(71) Applicant: CANON KABUSHIKI KAISHA, Tokyo (JP)

(72) Inventor: Takumi Kawamura, Utsunomiya-shi (JP)

(21) Appl. No.: 15/481,267

(22) Filed: Apr. 6, 2017

(30) Foreign Application Priority Data
Apr. 20, 2016 (JP) 2016-084731

(51) Int. Cl. G02B 5/00; G02B 27/02; G06F 1/16

(52) U.S. Cl. CPC G02B 5/003; G06F 1/1637; G02B 27/022; G06F 1/163

(57) ABSTRACT

A head mounted apparatus that prevents the influence of external light and is easy to use even for a user wearing glasses. The head mounted apparatus includes a display unit that displays an image to the user, and a light shielding member that shields a periphery of the user's eyes from external light when the head mounted apparatus is mounted on the user's head, wherein an opening is formed on the light shielding member at the user's orbital regions.

### BACKGROUND

### Field

the present disclosure relates to a head mounted apparatus to be placed on a user's head and a gripping apparatus that is gripped by the user.

### Description of the Related Art

a head mounted display (hereinafter referred to as a HMD) is mounted on a user's head when used. The HMD is provided with a display unit enabling the user to watch a screen image with a sense of realism through the display unit. Similarly, there is a handheld display (HHD) that the user grips to hold when used.

these apparatuses have been used in recent years in virtual reality (VR) technology for offering a realistic image. They have also been used in mixed reality (MR) technology for offering mixed reality by mixing a virtual world image with the real world without providing a feeling of strangeness to the user.

Depending on the external environment, external light can enter through a gap between the user and the display unit. The external light entering through the gap can reduce the contrast of the image displayed on the display unit, which can prevent offering of the realistic image. Japanese Patent Application Laid-Open No. 2001-228509 discusses a technique for providing a finder with a large-sized eyecup for preventing incidence of external light.

the eyecup discussed in Japanese Patent Application Laid-Open No. 2001-228509 can be attached to a HMD or HHD. However, when a user wearing glasses tries to wear the HMD, the eyecup can contact the user's glasses, making it difficult to wear the HMD.

### SUMMARY

Embodiments are directed to providing a head mounted apparatus or a gripping apparatus that prevent the influence of external light and are easy to use even for a user wearing glasses.

According to an aspect of the present disclosure, a head mounted apparatus mounted on a user's head when in use includes a display unit configured to display an image to the user, and a light shielding member configured to shield a periphery of the user's eyes from external light when the head mounted apparatus is mounted on the user's head. An opening is formed on the light shielding member at the user's orbital regions.

According to another aspect of the present invention, a gripping apparatus gripped by a use when in user includes a display unit configured to display an image to the user, and a light shielding member configured to shield a periphery of the user's eyes from external light when the gripping apparatus is gripped by the user. An opening is formed on the light shielding member at the user's orbital regions.

further features will become apparent from the following description of exemplary embodiments with reference to the attached drawings.

### BRIEF DESCRIPTION OF THE DRAWINGS

FIG. 1 illustrates an outer appearance of a head mounted apparatus according to a first exemplary embodiment.

FIG. 2 illustrates a state where a user wears the head mounted apparatus.

FIG. 3 illustrates an outer appearance of a display unit viewed from the user.

FIG. 4 illustrates an outer appearance of a light shielding member removed from the display unit.

FIGS. 5A, 5B, 5C, and 5D are respectively an elevational view, a top view, a side view, and a bottom view illustrating the light shielding member.

FIG. 6 is an elevational view illustrating a relation between the user and the light shielding member.

FIG. 7 is a side view illustrating a relation between the user and the light shielding member.

FIG. 8 is a bottom view illustrating a relation between the user and the light shielding member.

FIG. 9 illustrates an outer appearance of the light shielding member viewed from the user.

FIG. 10 is a top view illustrating the light shielding member.

FIG. 11A is a perspective view illustrating the light shielding member viewed from the display unit side, and FIG. 11B is an enlarged view illustrating a boss member.

FIG. 12A is an elevational view illustrating the display unit, and FIGS. 12B and 12C are respectively a sectional view and an enlarged view illustrating a whole portion provided on a front surface of the display unit.

FIGS. 13A and 13B are respectively a perspective view and an enlarged view illustrating a configuration of the light shielding member.

FIG. 14 is a perspective view illustrating an outer appearance of the head mounted apparatus viewed from obliquely below.

FIG. 15 is a perspective view illustrating the head mounted apparatus when a holding member is replaced with a gripping member.

FIG. 16 is a perspective view illustrating a light shielding member according to a second exemplary embodiment.

FIG. 17 is an elevational view illustrating a light shielding member according to a third exemplary embodiment.

FIGS. 18A and 18B are respectively a top view and a sectional view illustrating a light shielding member according to a fourth exemplary embodiment.

### DESCRIPTION OF THE EMBODIMENTS

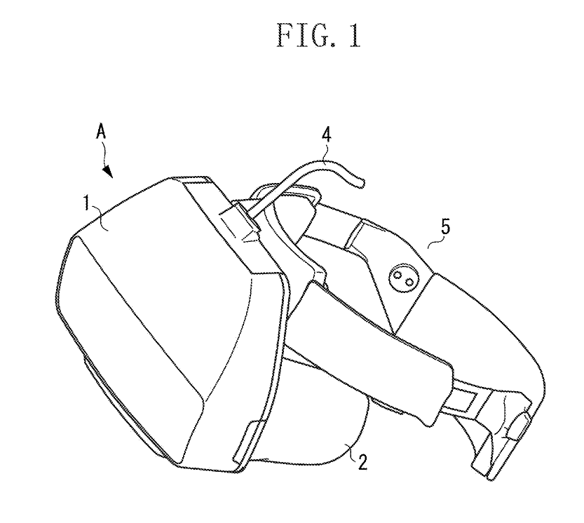

a first exemplary embodiment will be described in detail below with reference to the accompanying drawings. FIG. 1 is a perspective view illustrating a head mounted apparatus A according to the first exemplary embodiment.

the head mounted apparatus A according to the present exemplary embodiment includes a display unit 1, a light shielding member 2, and an attachable and detachable holding member 5. The display unit 1 is held by the holding member 5 so as to sit on the user's face. A harness 4 extends from above the display unit 1 and is connected with a video processing apparatus (not illustrated), such as a personal computer. The display unit 1 emits a video signal output from the video processing apparatus (not illustrated) toward the user's eyes.

the head mounted apparatus A according to the present exemplary embodiment includes an imaging unit. The user can see the image of the scenery in the line-of-sight direction captured by the imaging unit and displayed on the display unit. When the captured image is processed in intermediate steps before the display process, a virtual object or scenery can be superimposed on real scenery. For example, the head mounted apparatus A is suitable for product development in evaluating a design through three-dimensional (3D) data display, drilling for unusual disasters, or entertainment applications.

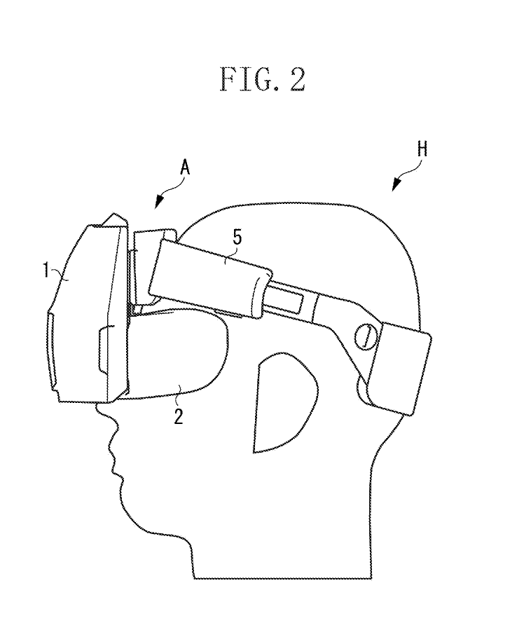

FIG. 2 is a side view illustrating a state where a user H wears the head mounted apparatus A. The light shielding member 2 located on the display unit 1 extends from the display unit 1 toward the user's face to cover the periphery of the user's eyes to block external light entering between the display unit 1 and the user H.

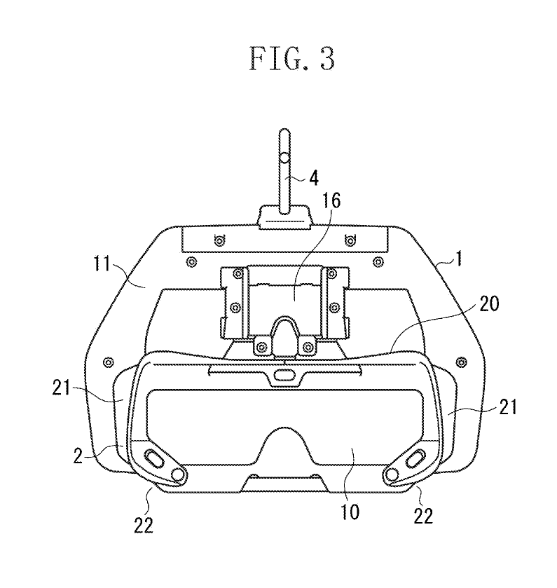

FIG. 3 is an elevational view illustrating the display unit 1 viewed from the user's perspective. In the present exemplary embodiment, the holding member 5 can be removed from the head mounted apparatus A. FIG. 3 illustrate a state where the holding member 5 is removed from the head mounted apparatus A. When the holding member 5 is removed from the head mounted apparatus A, an engaging member 16 for enabling the display unit 1 and the holding member 5 to engage with each other remains on a front surface 11 of the display unit 1. A display window 10 is provided on the front surface 11 of the display unit 1. Video light emitted from display elements (not illustrated) in the display unit 1 passes through the display window 10.

The light shielding member 2 includes a top surface 20, side surfaces 21, and bottom surfaces 22. The top surface 20 is located above the display window 10 and the user's eyes. The side surfaces 21 are located on both sides of the display window 10 and the user's eyes. The bottom surfaces 22 are located below the display window 10 and the user's eyes. The light shielding member 2 includes the above-described surfaces which are smoothly connected with each other.

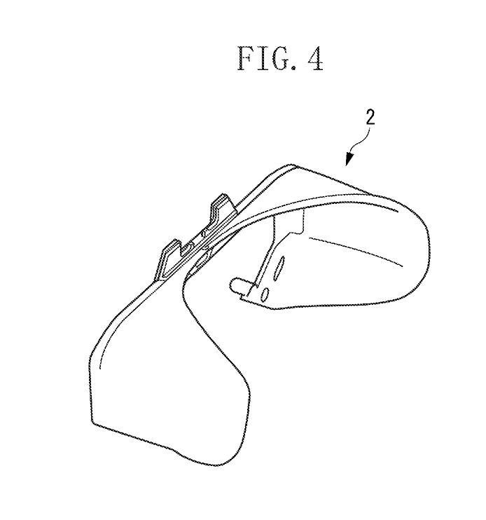

One of features of the present exemplary embodiment is a shape of a ridge line forming the edge of each surface configuring the light shielding member 2 on the user's face side. The shape of each ridge line of the light shielding member 2 will be described in detail below with reference to FIGS. 4 to 8.

FIG. 4 is a perspective view illustrating the light shielding member 2 as a single body removed from the display unit 1. In the present exemplary embodiment, the light shielding member 2 can be removed from the display unit 1 in this way. A specific attachment and detachment mechanism will be described below.

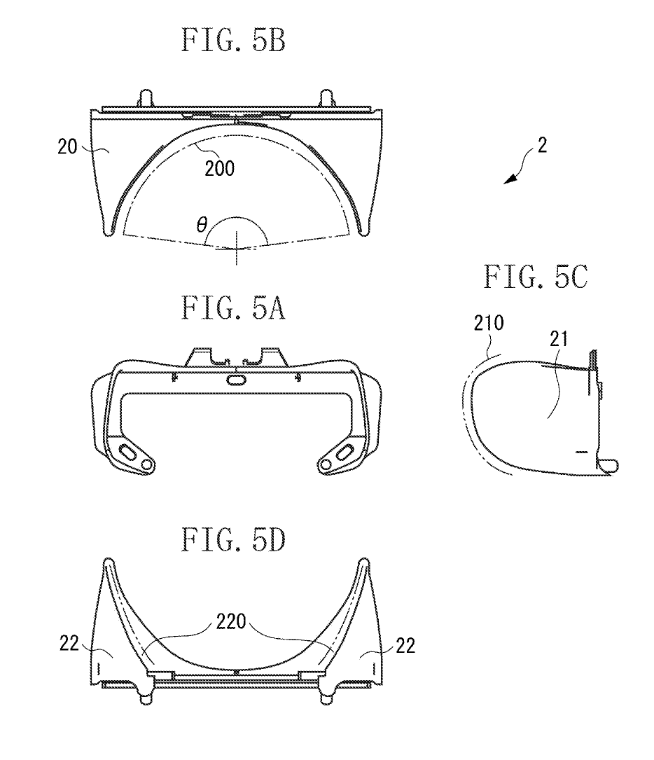

FIGS. 5A, 5B, 5C, and 5D are respectively an elevational view, a top view, a side view, and a bottom view illustrating the light shielding member 2. Projections illustrated in the top view (FIG. 5B), the side view (only one side) (FIG. 5C), and the bottom view (FIG. 5D) correspond to the top surface 20, a side surface 21, and the bottom surfaces 22, respectively. According to the present exemplary embodiment, the light shielding member 2 includes one top surface 20, two side surfaces 21, and two bottom surfaces 22. For example, when the light shielding member 2 is separated into right and left pieces that are separately used, each piece of the light shielding member 2 includes one top surface 20, one side surface 21, and one bottom surface 22. However, another configuration can be used within the scope of the present exemplary embodiment. The light shielding member 2 can include one top surface 20, two side surfaces 21, and one bottom surface 22. This configuration will be described as another exemplary embodiment.

Referring to the top view (FIG. 5B), the side view (only one side) (FIG. 5C), and the bottom view (FIG. 5D), a ridge line forming the edge of each surface on the user's face side is drawn by a two-point chain line. The two-point chain line illustrated in the top view (FIG. 5B) indicates a top ridge line 200 forming the edge of the top surface 20 on the user's face side. The two-point chain line illustrated in the side view (only one side) (FIG. 5C) indicates a side ridge line 210 forming the edge of the side surface 21 on the user's face side. The two-point chain lines illustrated in the bottom view (FIG. 5D) indicate bottom ridge lines 220 forming the edges of the bottom surfaces 22 on the user's face side. In the present exemplary embodiment, when the bottom view (FIG. 5D) is focused on, the curvature of the bottom ridge lines 220 is smaller than the curvature of the top ridge line 200. The bottom ridge lines 220 are positioned on an outward side relative to the top ridge line 200. From another viewpoint, the projection area of the bottom surfaces 22 is smaller than that of the top surface 20.

In the present exemplary embodiment, the top surface 20, both side surfaces 21, and both bottom surfaces 22 are all formed of elastic members. It is desirable that these surfaces are formed of elastic members since each ridge line forms at least the edge of each surface on the user's face side.

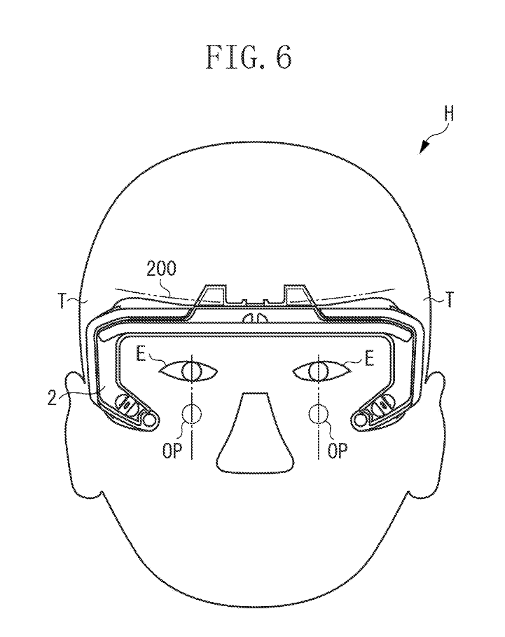

FIG. 6 is an elevational view illustrating a relation between the user H and the light shielding member 2. Hereinafter the user H wears the light shielding member as a single member in the drawings for the sake of description. However, the display unit 1 is actually positioned anteriorly to the user H. The shape of the top ridge line 200 will be described below with reference to FIG. 6.

The top ridge line 200 is shaped in such a way as to come in contact with the user's H forehead. This shape enables blocking of external light entering between the display unit 1 and the user H from above. The top ridge line 200 extends toward the user's H lower temple portions T to form an approximately semicircular arc. If the user H wears glasses, the temples of the glasses contact the user's H head at the lower temple portions T. It is desirable that the top ridge line 200 extends up to these contact portions. This prevents the light shielding member 2 from floating from the temporal regions of the user H by the temples of the glasses. Therefore, for both a user wearing glasses and a user without glasses, light entering from the backward of the side portions of the user H can be blocked. The top ridge line 200 is connected smoothly to the side ridge lines 210.

User head sizes vary in size. Therefore, it is desirable that the top ridge line 200 is of an approximately semicircular arc, based at least on or at an estimate of a smaller sized head. Even in a case where a smaller sized head is assumed, a user with a larger head can use the light shielding member 2 by expanding each surface thereof. The shape of the approximately semicircular arc of the top ridge line 200 is not limited to a semicircular shape with an arc center angle of 180 degrees, as illustrated in the top view (FIG. 5B). The arc center angle can be smaller than 180 degrees. For example, if a user's head is small, as can be in a case of a woman or a child, the arc center angle θ can exceed 180 degrees.

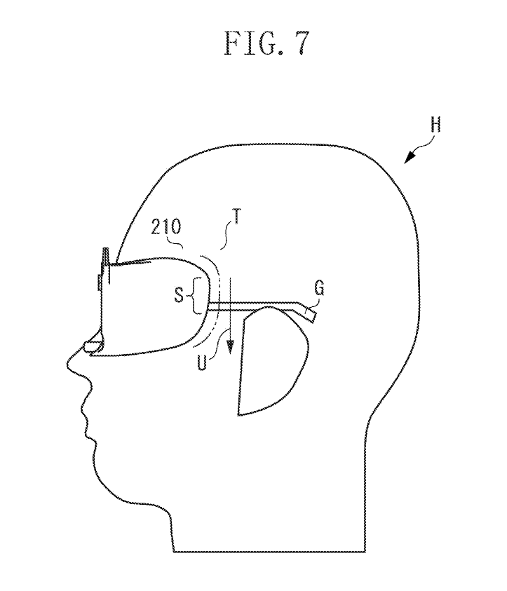

FIG. 7 is a side view illustrating a relation between the user H and the light shielding member 2. The shape of a side ridge line 210 will be described below with reference to FIG. 7.

The side ridge line 210 is shaped in such a way as to come in contact with the user's H lower temple portion T. The side ridge line 210 includes an approximately straight portion S extending in the perpendicularly downward direction (in the direction indicated by the arrow U) being in contact with the user's H head. Even if the position of a temple G of the glasses shifts in the vertical direction illustrated in FIG. 7 due to individual variations, owing to the approximately straight portion S extending in the perpendicularly downward direction, it is possible to reliably press the portion where the temple G of the glasses contacts the head toward the head side. Subsequently, the side ridge line 210 is smoothly connected to a bottom ridge line 220.

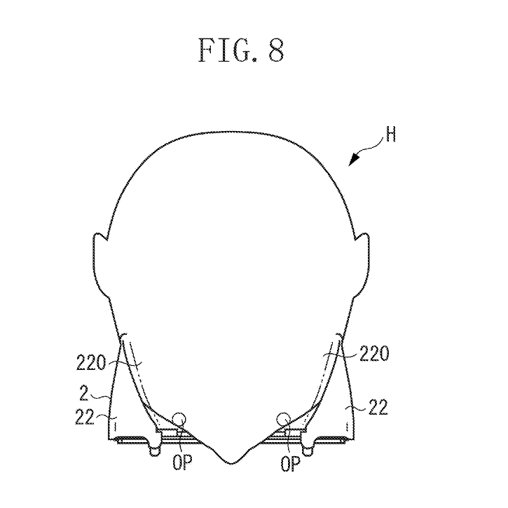

FIG. 8 is a bottom view illustrating a relation between the user H and the light shielding member 2. The shape of a bottom ridge line 220 will be described below with reference to FIG. 8.

The bottom ridge line 220 advances toward an orbital point OP being in contact with the user's H face. The orbital point OP refers to the point directly below the user's pupil on the bottom edge of a cavity in the user's skull containing an eyeball, referred to as the eye socket (refer to FIG. 6 illustrating the user's pupils E and the user's H orbital points OP). The bottom ridge line 220 gradually changes the direction so as to anteriorly separate from the user's H face. Before reaching the orbital point OP, the bottom ridge line 220 completely separates from the user's H face. According to the present exemplary embodiment, the bottom ridge line 220 breaks off at the completely separate point. More specifically, an opening is formed in the vicinity of the user's H orbital region.

Because of the shape of the bottom ridge line 220, the bottom surface 22 of the light shielding member 2 is provided with a space including a shape which is wide on the user's H face side and narrow on the side of the display unit 1. As described above, in the present exemplary embodiment, the curvature of the bottom ridge line 220 is smaller than the curvature of the top ridge line 200. The bottom ridge line 220 is positioned on the outward side relative to the top ridge line 200. From another viewpoint, the projection area of the bottom surface 22 is smaller than the projection area of the top surface 20. Because of the shape of the bottom surface 22 including these features, the space provided on the light shielding member 2 is wider on the user's H face side. Therefore, if the user H wears glasses, this space can prevent the glasses from getting stuck on/contacting the light shielding member 2. An action taken in this case would be to remove the head mounted apparatus A from the user's H head by upwardly or anteriorly orienting the light shielding member 2 (or the display unit 1 having the light shielding member 2) and then moving the light shielding member 2 obliquely upward.

The present exemplary embodiment provides another effect that the user H can view the user's H feet. A known use application of an HMD is for a user to wear the HMD while walking. In this case, if the peripheral view is completely covered by using the light shielding member 2, the user H needs to perform a superfluous action to move the user's H head to view the user's feet. The present exemplary embodiment enables the user H to easily and naturally view the user's feet even when the user H is using the light shielding member 2, and is suitable for a case where the user H is walking while observing.

The present exemplary embodiment provides another effect that, when the light shielding member 2 is used, the air tightness of the face portion covered by the light shielding member 2 is low, preventing build-up of moisture. Moisture build-up can result in the display window of the display unit 1 misting-up and/or the user's H face steaming up. The present exemplary embodiment provides an effect of reducing such displeasure.

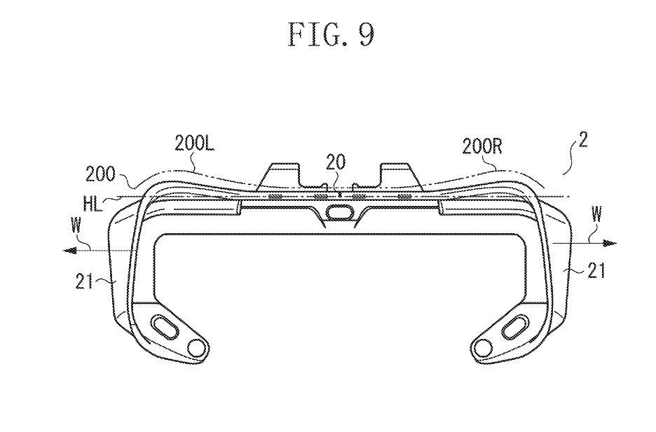

FIG. 9 is an elevational view illustrating the light shielding member 2 viewed from the user's H perspective. Additional features of the top surface 20 of the light shielding member 2 according to the present exemplary embodiment will be described below with reference to FIG. 9.

The top ridge line 200 includes a left curved portion 200L and a right curved portion 200R with respect to a horizontal line HL when viewed from the user's H perspective. More specifically, the top surface 20 is provided with portions upwardly curved compared with a simple flat surface on the right and left sides. In addition, both surfaces 21 on the right and left sides are inwardly inclined from the edge on the side of the display unit 1 toward the edge on the side of the user H. The root portions of the top surface 20 and the side surfaces 21 on the display unit 1 side are provided with sufficient spaces for accommodating glasses.

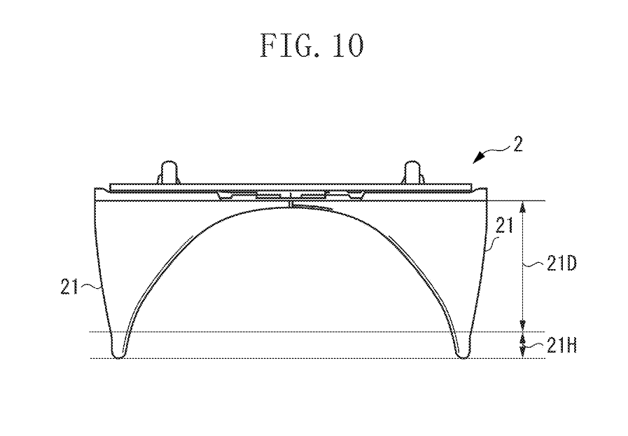

FIG. 10 is a top view illustrating the light shielding member 2. While each of both side-surfaces 21 include an inwardly inclined shape as a whole as described above, an area 21D on a display unit side and an area 21H on a user's side have different inclinations. In the present exemplary embodiment, the user unit side area 21H includes a gentler inclination than the display unit side area 21D. When both side-surfaces 21 are compared, the display unit side area 21D and the user side area 21H have different curvatures. In the present exemplary embodiment, the user side area 21H is a flatter surface than the display unit side area 21D. Since these flat surfaces enable pressing the periphery of the temples of the glasses against the sides of the temporal regions, the light shielding member 2 is likely to fit the temples of the glasses, reducing the float of the light shielding member 2. That is, the light shielding performance of the side surfaces 21 improves for glasses-wearing user.

As described above, elastic members are suitable for the light shielding member 2 since the light shielding member 2 comes in contact with the user's H face. If at least the top surface 20 is made of an elastic member, when the above-described curved portions is deformed so as to approach a flat surface, the side surfaces 21 can outwardly incline (in the directions of the arrows W illustrated in FIG. 9) when viewed from the user's H perspective. More specifically, the curved surfaces of the top surface 20 according to the present exemplary embodiment functions as spread margins necessary for causing the side surfaces 21 to incline outwardly (in the directions of the arrows W illustrated in FIG. 9).

By providing spread margins formed of curved surfaces on the top surface 20 in this way, the side surfaces 21 inclines outwardly (in the directions of the arrows W illustrated in FIG. 9) until the curved surfaces become flat. The force required for this operation is smaller than the tensile force applied to extend the elastic member itself. Thus, even if the side surfaces 21 have a shape inwardly inclined toward the user's H face, the side surfaces 21 tend to incline in a direction of avoiding the glasses' frames or temples when brought into contact with the side surfaces 21. Thus, an effect of preventing the glasses from easily getting caught on the light shielding member 2 is produced. When the light shielding member 2 is pressed onto the face, both side surfaces 21 tend to incline outwardly (in the directions of the arrows W illustrated in FIG. 9). Therefore, a feeling of tightness that the user H with a larger sized head has on the temporal regions can be reduced and a favorable fitting feeling can be obtained.

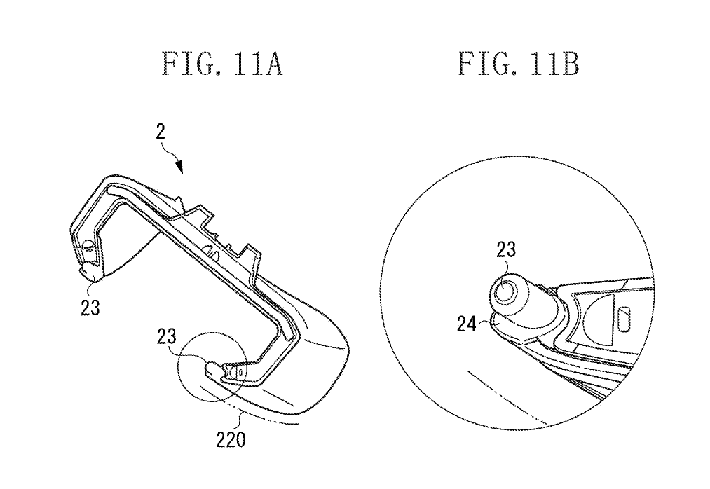

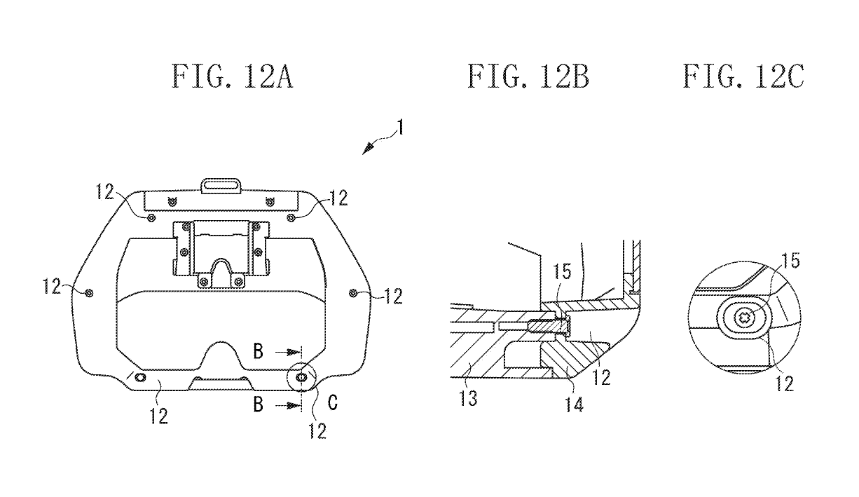

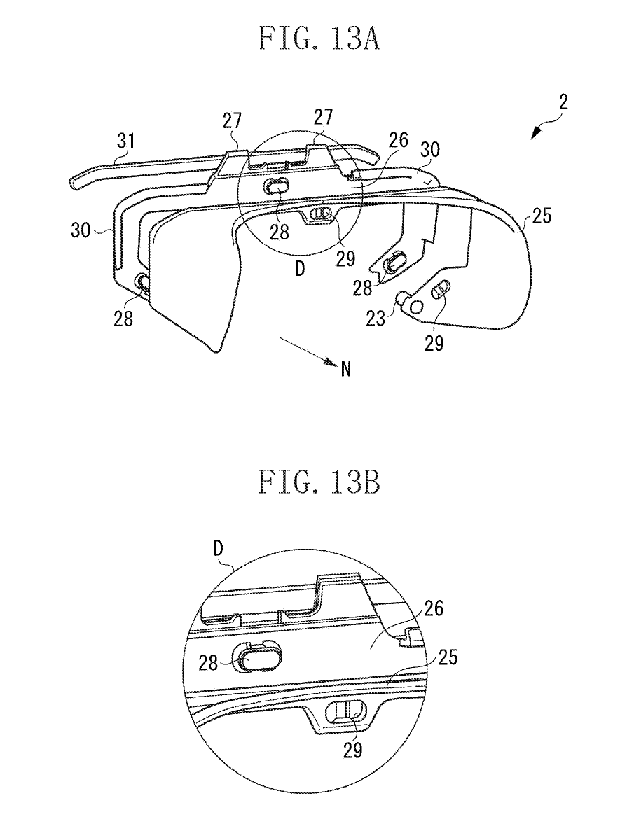

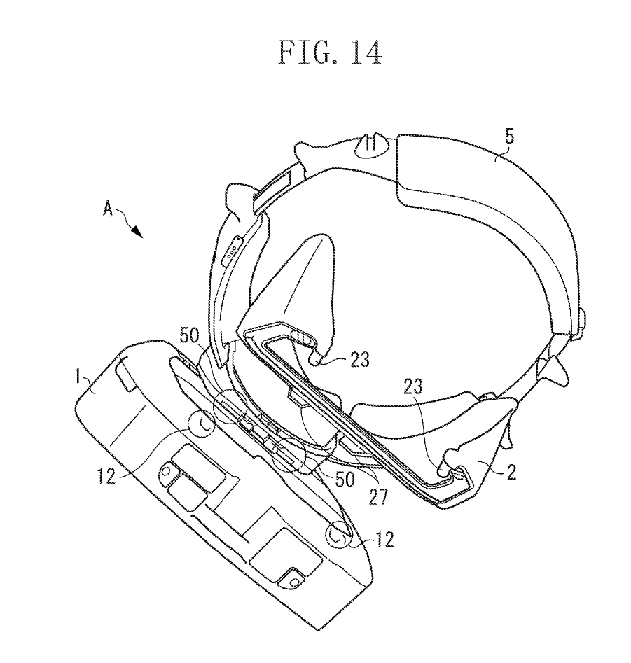

FIG. 11A is a perspective view illustrating the light shielding member 2 viewed from the side of the display unit 1, and FIG. 11B is an enlarged view illustrating a boss member (convex member) 23. FIG. 12A is an elevational view illustrating the display unit 1. FIGS. 12B and 12C are respectively a sectional view and an enlarged view illustrating a hole portion (concave portion) 12 provided on the front surface 11 of the display unit 1. FIGS. 13A and 13B are respectively a perspective view and an enlarged view illustrating a configuration of the light shielding member 2. FIG. 14 is a perspective view illustrating an outer appearance of the head mounted apparatus A, which indicates procedures for attaching the light shielding member 2 to the head mounted apparatus A. A mechanism for attaching and detaching the light shielding member 2 to/from the display unit 1 will be described below with reference to FIGS. 11A to 14.

The boss member 23 illustrated in the perspective view in FIG. 11A is provided at the edge of the bottom ridge line 220. As illustrated in the enlarged view in FIG. 11B, a contact portion 24 for contacting the display unit 1 is located at the root of the boss member 23.

The display unit 1 illustrated in FIG. 12A is provided with a plurality of hole portions 12. As illustrated in the sectional view in FIG. 12B, a hole portion 12 includes a function of a counter sunk hole for a screw 15 for coupling an anterior exterior 13 and a face side exterior 14 configuring the display unit 1. As illustrated in the enlarged view of the hole portion 12 in FIG. 12C, some of the hole portions 12 are oblong holes. Each hole portion 12 includes a taper.

As illustrated in FIG. 13A, the light shielding member 2 according to the present exemplary embodiment is composed of three different parts. A face contact member 25 comes in contact with the user's H face to block and prevent external light from entering between the display unit 1 and the user H. A base portion 26 is provided to maintain the shape of the face contact member 25 when it is attached to the display unit 1. The base portion 26 has higher rigidity than the face contact member 25. According to the present exemplary embodiment, the base portion 26 is provided with male coupling portions 28 (at three positions) and the face contact member 25 is provided with female coupling portions 29 (at three positions, one position not illustrated). As illustrated in the enlarged view in FIG. 13B, the male coupling portion 28, made of an elastic member, is fit into the female coupling portion 29 while being expanded. The base portion 26 also includes hooking portions 30 on the right and left sides which stretch the face contact member 25 in the circumferential direction. Thus, a shape of the face contact member 25 is maintained by the base portion 26. With this configuration, when the face contact member 25 is stained, only the face contact member 25 can be removed and easily washed. The base portion 26 includes protruding portions 27 in the direction approximately perpendicular to the arrow N.

The light shielding member 2 includes a light shielding auxiliary member 31. The light shielding auxiliary member 31 is stuck onto the base portion 26 in the direction of the arrow N (in the user's H face direction). The light shielding auxiliary member 31 is made of an elastic member. The light shielding auxiliary member 31 is stuck onto the front surface 11 of the display unit 1 according to the shape of the front surface 11 to block and prevent external light from entering between the front surface 11 and the base portion 26 to improve the light shielding performance.

FIG. 14 is a perspective view illustrating an outer appearance of the head mounted apparatus A viewed from diagonally below. Gaps 50 are formed between the display unit 1 and the holding member 5. The protruding portions 27 provided on the base portion 26 are inserted into the gaps 50. While, in the present exemplary embodiment, the display unit 1 and the holding member 5 are detachably attached to each other, the display unit 1 and the holding member 5 need not be detachably attached as long as the above-described gaps 50 are provided. The boss members 23 of the light shielding member 2, made of elastic members, are press-fit into the hole portions 12 of the display unit 1 so that the light shielding member 2 is fit into place.

In the configuration of the present exemplary embodiment, since there are only two press-fitting portions, the user H needs to perform pushing and pulling actions by only applying a small force a small number of times, which makes it easier to perform attachment and detachment. Since the counter sunk holes are used for screws of the display unit 1 as described above, appearance of the apparatus is not degraded regardless of whether the light shielding member 2 is present. Even when the light shielding member 2 is removed from the display unit 1, there remains no projection on the face side, which makes handling of the apparatus safer. Thus, in the present exemplary embodiment, the user H can easily select whether to attach the light shielding member 2.

The light shielding member 2 according to the present exemplary embodiment can be easily attached and detached. At the same time, since the boss members 23 are approximately perpendicular to the front surface 11, when the head mounted apparatus A is removed from the user's H head, the light shielding member 2 can be stably fixed against a force in the shearing direction. In a mounting action in this case, the light shielding member 2 (or the display unit 1 having the light shielding member 2) is upwardly or anteriorly oriented to move the light shielding member 2 obliquely upward or in the opposite direction. The protruding portions 27 extending in a direction different from the boss members 23 can stably fix the light shielding member 2 to the front surface 11 of the display unit 1 not only in the shearing direction but also in the tensile direction.

When the protruding portions 27 are inserted into the above-described gaps 50, the light shielding auxiliary member 31 made of an elastic member interferes with the front surface 11 of the display unit 1 and is deformed to produce resistance. This reactive force has a biasing effect that prevents getting rickety between the display unit 1 and the holding member 5 through the protruding portions 27.

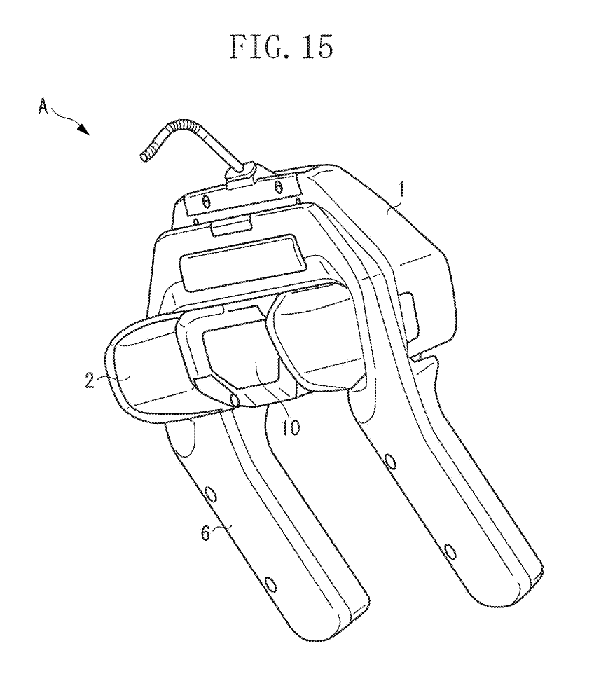

FIG. 15 is a perspective view illustrating the head mounted apparatus A that functions as a gripping apparatus when the holding member 5 has been replaced with a gripping member 6. The user H can attach the gripping member 6 to the display unit 1, as illustrated in FIG. 15. In this case, the user H grips the gripping member 6 with both hands, supports the display unit 1 in front of the user's H face, and observes an image through the display window 10. In this way, the light shielding member 2 according to the present exemplary embodiment is configured to be detachably attached even when the display unit 1 is not to be fixed to the user's H head.

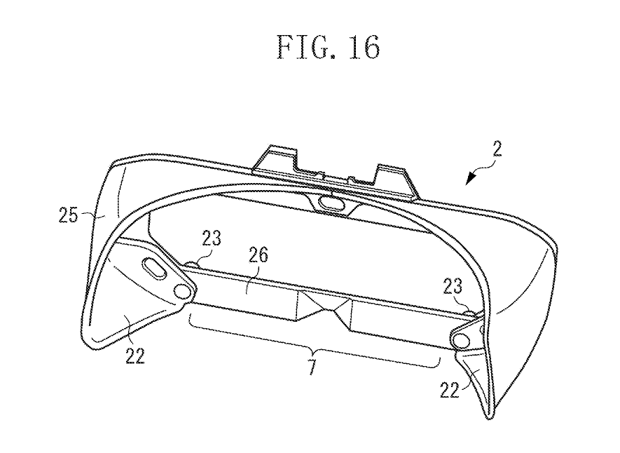

FIG. 16 is a perspective view illustrating the light shielding member 2 according to a second exemplary embodiment. Unlike the above-described first exemplary embodiment, a beam 7 for connecting between the user's H right and left temporal regions is located across the bottom surfaces 22. According to the present exemplary embodiment, the beam 7 is located at the base portion 26 supporting the face contact member 25. It is desirable that the thickness of the beam 7 is less than the distance from the front surface 11 of the display unit 1 to the surface of the glasses of the user H. Thus, the glasses tend not to get caught the bottom surfaces 22 of the light shielding member 2 to the degree similar to the first exemplary embodiment. Providing the beam 7 improves the rigidity of the light shielding member 2. Also in the present exemplary embodiment, a plurality of boss members 23 is provided to fix the light shielding member 2 to the display unit 1. Owing to high rigidity, the light shielding member 2 can be easily removed by pulling out a plurality of bosses in one action. Since the area that is in close contact with the front surface 11 of the display unit 1 is increased, stable fixation can be achieved. Other features are similar to those of the first exemplary embodiment and redundant descriptions thereof will be omitted.

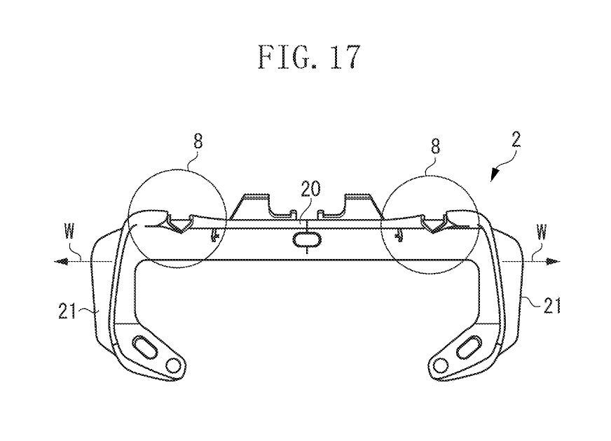

FIG. 17 is an elevational view illustrating the light shielding member 2 according to a third exemplary embodiment. Unlike the above-described first exemplary embodiment, spread margins include a folding shape. As the spread margins, folds 8 are formed at two (right and left) positions on the top surface 20. With this configuration, the inclinations of both side surfaces 21 can be further gained in the directions of the arrows W compared with the spread margins according to the first exemplary embodiment. Thus, it is possible to reduce the possibility that the frames or temples of the glasses get caught on the light shielding member 2 when removing the head mounted apparatus A from the user's H head. If the number of the folds 8 is increased to provide bellows-like spread margins, a problem will not exist if the user H wears a larger set of glasses. Thus, feeling of tightness which the user H with a larger sized head has can be reduced on the temporal regions and favorable fitting feeling can be obtained. Other features are similar to those of the first exemplary embodiment and redundant descriptions thereof will be omitted.

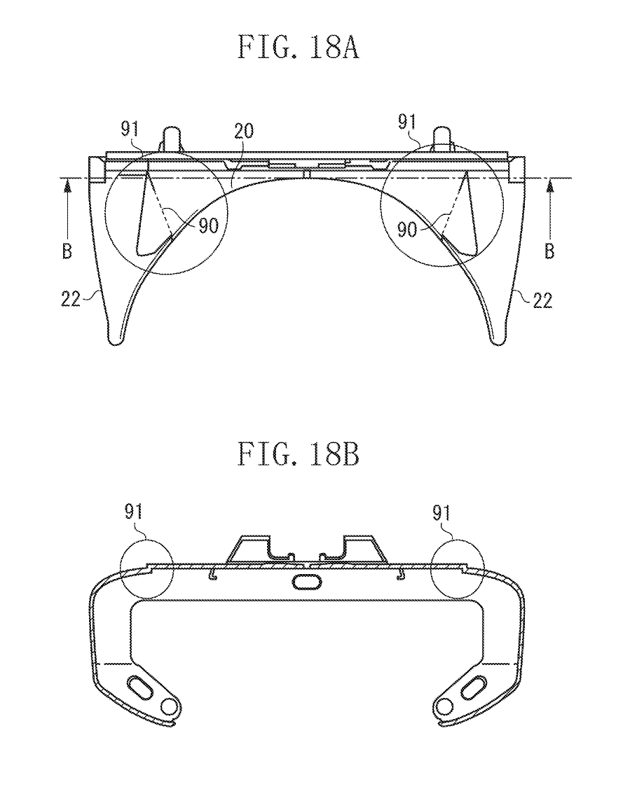

FIGS. 18A and 18B are respectively a top view and a sectional view illustrating the light shielding member 2 according to a fourth exemplary embodiment. Unlike the above-described first exemplary embodiment, spread margins are formed of cut portions 90 drawn by dashed lines and overlapping margins 91. As spread margins, the cut portions 90 are located at two (right and left) positions on the top surface 20. While the cut portions 90 can alone function as spread margins, the overlapping margins 91 are formed to compensate for the light shielding function. FIG. 18B is a sectional view illustrating the light shielding member 2 viewed in the direction of the arrow B. In this way, the top surface 20 is doubly lapped in the overlapping margins 91. Therefore, even if the cut portions 90 spread as both side surfaces 21 outwardly spread, the light shielding performance of the top surface 20 can be maintained. Therefore, also with this configuration, the possibility that the frames or temples of the glasses get caught on the light shielding member 2 is reduced. Thus, feeling of tightness which the user H with a larger sized head has can be reduced on the temporal regions and favorable fitting feeling can be obtained. Other features are similar to those of the first exemplary embodiment and redundant descriptions thereof will be omitted.

While descriptions of the above-described exemplary embodiments have been provided, they are not seen to be limiting, and can be modified in diverse ways within the ambit of the appended claims.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-084731, filed Apr. 20, 2016, which is hereby incorporated by reference herein in its entirety.

What is claimed is:

1. A head mounted apparatus mounted on a user's head when in use, comprising:
a display unit configured to display an image to the user; and
a light shielding member configured to shield a periphery of the user's eyes from external light when the head mounted apparatus is mounted on the user's head,
wherein an opening is formed on the light shielding member at the user's orbital regions.

2. The head mounted apparatus according to claim 1, wherein the light shielding member is formed of elastic members and is deformed along a shape of the user's head when the head mounted apparatus is mounted on the user's head.

3. The head mounted apparatus according to claim 1,
wherein the light shielding member includes convex portions,
wherein the display unit includes concave portions, and
wherein, when the convex portions fit into the concave portions, the light shielding member and the display unit are detachably attached to each other.

4. The head mounted apparatus according to claim 3, wherein the concave portions are counter sunk holes for screws of the display unit.

5. The head mounted apparatus according to claim 1, further comprising a holding member configured to hold the head mounted apparatus in place when mounted, wherein, when parts of the light shielding member are inserted into gaps formed between the holding member and the display unit, the light shielding member is held relative to the display unit.

6. The head mounted apparatus according to claim 5,
wherein the light shielding member is formed of elastic members and a base portion having higher rigidity than the elastic members, and
wherein, when parts of the base portion are inserted into the gaps formed between the holding member and the display unit, the light shielding member is held relative to the display unit.

7. The head mounted apparatus according to claim 1,
wherein, the light shielding member is outwardly inclined at the user's forehead to provide spread margins, and
wherein the light shielding member is inwardly inclined at the user's temporal regions.

8. The head mounted apparatus according to claim 7, wherein, in the light shielding member, a portion contacting the user and a portion not contacting the user have different curvatures of inclination.

9. The head mounted apparatus according to claim 7, wherein the spread margins partly have a curved shape.

10. The head mounted apparatus according to claim 7, wherein the spread margins partly have a folding shape.

11. The head mounted apparatus according to claim 7, wherein the spread margins are partly formed of a cut portion on the light shielding member.

12. The head mounted apparatus according to claim 1, wherein, in the opening, a beam for connecting right and left temporal region sides of the user's head is arranged.

13. A gripping apparatus gripped by a user when in use, comprising:
a display unit configured to display an image to the user; and
a light shielding member configured to shield a periphery of the user's eyes from external light when the gripping apparatus is gripped by the user,
wherein an opening is formed on the light shielding member at the user's orbital regions.
